(19) United States
(12) Patent Application Publication
(10) Pub. No.: US 2013/0218789 A1
(43) Pub. Date: Aug. 22, 2013

(54) Systematic Approach to Enforcing Contiguity Constraint in Trajectory-based Methods for Combinatorial Optimization

(71) Applicant: University of South Carolina, (US)

(72) Inventor: Diansheng Guo, Columbia, SC (US)

(73) Assignee: UNIVERSITY OF SOUTH CAROLINA, Columbia, SC (US)

(21) Appl. No.: 13/772,769

(22) Filed: Feb. 21, 2013

Related U.S. Application Data
(60) Provisional application No. 61/601,162, filed on Feb. 21, 2012.

(51) Int. Cl. G06Q 50/26; G06Q 30/00

(52) U.S. Cl. CPC G06Q 50/26; G06Q 30/018
USPC 705/317

(57) ABSTRACT

A computer implemented method for enforcing geographic contiguity of an optimization method for redistricting is described. The method includes randomly grouping a data set of objects into geographically contiguous districts, optimizing the objects by iteratively moving one or more objects between neighboring districts, wherein a relationship of objects is analyzed in each district to determine a minimal set of objects that will move together to maintain contiguity between districts, and generating one or more solutions for the data set.

### CROSS-REFERENCE TO RELATED APPLICATION

The present application is based on and claims priority to U.S. Provisional Application 61/601,162 having a filing date of Feb. 21, 2012, which is incorporated by reference herein.

### GOVERNMENT SUPPORT CLAUSE

This invention was made with government support under grant number BCS 0748813 awarded by National Science Foundation. The government has certain rights in the invention.

### BACKGROUND

Many combinatory optimization problems, such as redistricting and location allocation, need to satisfy a geographic contiguity constraint so that each solution is a set of geographically contiguous regions (e.g., congressional districts or coverage areas). Political redistricting is the process of redrawing boundaries of legislative districts at various administrative levels, such as congressional districts, state legislative districts, and county council districts. Redistricting has attracted extensive research interests in multiple disciplines, such as geography, political science, law, computer science, mathematics and statistics. Many of these research efforts have focused on developing redistricting optimization methods, which can leverage the computational power to help group a set of spatial objects into a specified number of geographically contiguous districts while optimizing a given objective function.

The automatic generation and optimization of redistricting plans can be achieved with different methodologies, such as clustering, location-allocation, space partitioning, graph partitioning, genetic algorithms, Tabu search, and simulated annealing. However, redistricting is a combinatory optimization problem that has been shown to be NP-hard and intractable. Therefore, most methods are heuristic-based and aim to find near-optimal solutions. The objective function for redistricting optimization often involves multiple criteria and constraints such as (1) geographic contiguity constraint; (2) equal population for each district; (3) compactness of district shape; and (4) preserving community of interest. Such a mix of constraints and criteria presents several challenges. On one hand, the optimization method needs to explore a large search space to find high-quality solutions. On the other hand, however, maintaining the geographic contiguity during the optimization process may severely limit the search space in the optimization process, make it very difficult to escape local optima, and therefore cannot guarantee optimization quality.

Automated redistricting algorithms may be classified into three groups: bottom-up agglomerative methods, top-down divisive methods, and heuristic-based search methods. Bottom-up agglomerative methods aggregate “similar” objects into regions under a contiguity constraint. There can be a hierarchical process that iteratively merges small clusters until reaching the desired number of clusters (districts). This group of methods include location-allocation methods and multi-kernel growth techniques. However, districting plans generated by agglomerative methods are usually of low quality in terms of criteria measures since the redistricting criteria cannot be directly optimized with such bottom-up growing processes (since the plan is not completed until the algorithm finishes). Such methods maintain the contiguity of each district by only adding neighbors to growing districts (clusters). The advantage of agglomerative methods is that they are fast and therefore can serve as a starting point by providing initial plans that will be further optimized with other heuristic-based search methods.

Top-down divisive methods start from the whole dataset and attempt to partition it into a desired number of regions (districts). Integer programming is considered a top-down approach since it incorporates all variables into a mathematical model and then solves the model to find the “best” solution (partition). However, it is very difficult to express redistricting constraints and criteria with integer linear programming. For example, the task of ensuring contiguity alone will require a large number of variables to be defined in an integer programming model, which in practice has limited applicability. Therefore, integer linear programming is not commonly used in redistricting where contiguity must be guaranteed.

The third group covers various heuristic based search and optimization methods. Most of these methods start with an initial plan (which may be generated with a fast method based on random growth) and then to improve it by iteratively moving objects between neighboring districts. A sequence of such moves (i.e., a trajectory) usually leads to a better solution than the initial one. Such methods include: local greedy search or hill climbing, simulated annealing, Tabu search, and dynamically weighted Voronoi diagrams. A hill-climbing approach finds the best move at each step and stops when there is no move can produce a better objective value. Therefore it cannot escape local optima. Simulated Annealing (SA) makes a random move at each step and accepts non-improving moves with a probability (which becomes smaller as the temperature goes down). SA can escape local optima at the early stage when the temperature is high. However, to reach a satisfactory result, SA often needs a slow cooling and a long trajectory of moves. Therefore, simulated annealing is very time consuming and practically not suited for combinatory optimization.

Tabu search is a special trajectory-based search method that finds the best move at each step even if the move is non-improving. A Tabu method keeps a list of objects that have recently been moved, which are prohibited to move again. This list is called the tabu list and is a queue of a certain length (i.e., tabu length k). When an object is moved, it is inserted to the end of the queue. If the queue is full (i.e. having more than k objects), then the first object in the queue will be dropped and can move again. Periodically, the Tabu list is cleared and all objects can move (which is called restart). The Tabu search stops at a predefined condition such as reaching a specified maximum number of moves or a maximum number of consecutive non-improving moves. Existing research shows that Tabu methods generally are better than other methods in combinatory optimization.

Genetic algorithms are different in that they start with a set of initial plans (i.e., not just one), rank each plan with a score, and then randomly pair the top plans to produce the next generation of plans based on a set of operators such as mutation and crossover. In the reproduction of new plans, extra steps are necessary to enforce the contiguity of the new plans. The evolution process will stop at a predefined condition. During the evolution, the best plan is recorded and reported at the end. Although genetic algorithms have been useful for many applications domains, redistricting poses unique challenges for genetic algorithms, especially with the population equality criterion.

Contiguity constraint in combinatorial optimization is generally handled with two alternatives. One is to “encourage” contiguity through the objective function definition such as incorporating distance in the measure so that nearby objects tend to be grouped together. This strategy cannot guarantee contiguity in the final solution. The other option is to enforce contiguity throughout the optimization process. For example, to ensure contiguity in an integer programming method, a large number of variables need to be defined, which can be very challenging and inefficient to achieve. For trajectory-based optimization methods such as a Tabu search or local greedy search, an object can only move if it does not break the contiguity. This strategy can guarantee contiguity but it dramatically reduces the number of potential moves and thus adversely affects the optimization power and makes it difficult to escape local optimal for better solutions.

As such, a need exists for an approach that assures geographic contiguity and at the same time dramatically expands the search space and significantly improves optimization quality for trajectory-based metaheuristic methods.

### SUMMARY

In accordance with certain embodiments of the present disclosure, a computer implemented method for enforcing geographic contiguity of an optimization method for redistricting is described. The method includes randomly grouping a data set of objects into geographically contiguous districts, optimizing the objects by iteratively moving one or more objects between neighboring districts, wherein a relationship of objects is analyzed in each district to determine a minimal set of objects that will move together to maintain contiguity between districts, and generating one or more solutions for the data set.

Other features and aspects of the present disclosure are discussed in greater detail below.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figures in which:

Table 1 illustrates candidate moves and switches for the data shown in FIG. 1.

Table 2 illustrates different optimization methods that are implemented and compared.

Table 3 illustrates performance evaluation with Iowa Data.

Table 4 illustrates performance evaluation with Iowa data, optimizing both population equality (PopDev) and shape compactness with equal weights.

FIG. 1 illustrates an example data set to demonstrate candidate moves under contiguity constraint.

FIG. 2 illustrates the contiguity relationship among the spatial objects in the district C in FIG. 1.

FIG. 3 illustrates composite moves (i.e., multi-object moves) for cut points.

FIG. 4 illustrates the Tabu search algorithm to optimize an initial redistricting plan.

FIG. 5 illustrates the population of 99 Iowa counties from the 2000 census data.

FIG. 6 illustrates comparing the performance of Tabu and Tabu* (see Table 3 for the data).

FIG. 7 illustrates selected Iowa congressional redistricting plans generated by the Tabu* method.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The present disclosure presents an approach that systematically and efficiently maintains contiguity for trajectory-based combinatorial optimization methods such as Tabu search, local greedy search, and simulated annealing. The described approach analyzes the contiguity relationship among spatial objects and allows single-object moves, multiple-object moves, and exchanges of multiple objects during the optimization process. The approach dramatically expands the search space, significantly improves optimization quality, and yet is efficient with several novel strategies for enforcing contiguity and evaluating moves. A suite of algorithms is presented for identifying candidate moves under contiguity constraint and a new Tabu search method that integrates the above contiguity enforcing approach. A series of experiments was conducted to evaluate the optimization power of the new method and compare it with several existing methods including a traditional Tabu, greedy local search, Kernighan-Lin algorithm, and a genetic algorithm. The new method significantly outperforms existing methods in terms of optimization quality, reliability, and efficiency.

The core component in the described methods is a process that iteratively moves objects to explore different solutions and a trajectory of such moves leads to the final and much better solution. To enforce the contiguity constraint in this search process, the approach of the present disclosure analyzes the contiguity relationship among objects and identifies all candidate moves, including both single-object moves and multiple-object moves. If an object cannot move due to the contiguity constraint, the described approach will find a minimal set of objects to move together with the object in order to maintain contiguity.

The approach can be combined with any existing trajectory-based optimization method, such as the Tabu search, Kernighan-Lin method, or local greedy search, to improve each method's optimization power under contiguity constraint. It has been determined that the combination with a Tabu method gives the most superior performance. Therefore, certain aspects of the present disclosure are directed to an optimization method that includes a Tabu search combined with the contiguity-enforcing approach. In addition to the improved optimization power, the disclosed approach also achieves better efficiency through several strategies in handling contiguity and evaluating candidate moves. The overall and simplified optimization procedure is outlined in Algorithm 1. Since the method is efficient, it can be repeated (Step 4) to generate a collection of high-quality plans, which the user can evaluate and choose based on domain knowledge and individual preference.

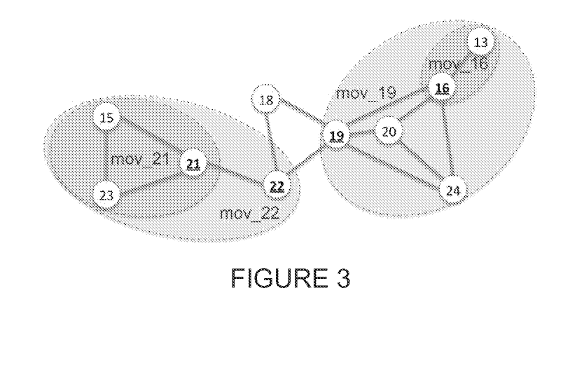

Algorithm 1: General Steps
(Details are explained in Algorithms 2-3 and Figure 4)

```
1. Initialization—create an initial plan randomly;
2. Optimization—repeat the following steps until a stop condition is met:
    a. Find all candidate moves within the current solution;
    b. Find the best move among all candidates, or the best switch of two
      candidate moves, according to an objective function f;
    c. Accept the best move or switch to modify the current solution,
      update the best solution if the new solution is better;
3. Output—output the best solution recorded during the optimization.
4. Repetition (Optional)—repeat steps 1-3 to generate a set of alternative
  solutions, which the user can interactively examine and compare.
```

Initialization under Contiguity Constraint

A simple seed-growing method is utilized to generate an initial redistricting plan, which randomly groups objects into r geographically contiguous districts (see Algorithm 2). First, r seeds (spatial objects) are selected randomly, each representing a district. Then districts grow one at a time by adding a non-assigned neighboring object to it. This process repeats until all objects are assigned to a district.

Algorithm 2: Initialization

```
Input:
  S: a set of spatial objects, |S| = n;
  C: a n*n contiguity matrix;
  r: the number of districts, 1< r << n;
Steps:
  1.Randomly select r objects from S, each being a district Dₘ, m = 1 .. r;
  2. For each district Dₘ:
    a. Randomly select one of its unassigned neighbors b (if any);
    b. Assign b to Dₘ;
  3. Repeat step 2 until all objects in S are assigned to a district.
```

Other methods may also be used to generate an initial plan. It is not critically important which initialization method is used as long as it is a random process and can generate different plans if repeated. The initialization method in Algorithm 2 ensures that each district is geographically contiguous but does not consider any other redistricting criteria.

Candidate Moves under Contiguity Constraint

Given an initial plan of r districts, a Tabu search is used to optimize an objective function. Tabu search is a trajectory-based optimization method, which iteratively moves objects between neighboring districts to search for better solutions. The contiguity constraint poses major challenges for optimization which are addressed by the present disclosure.

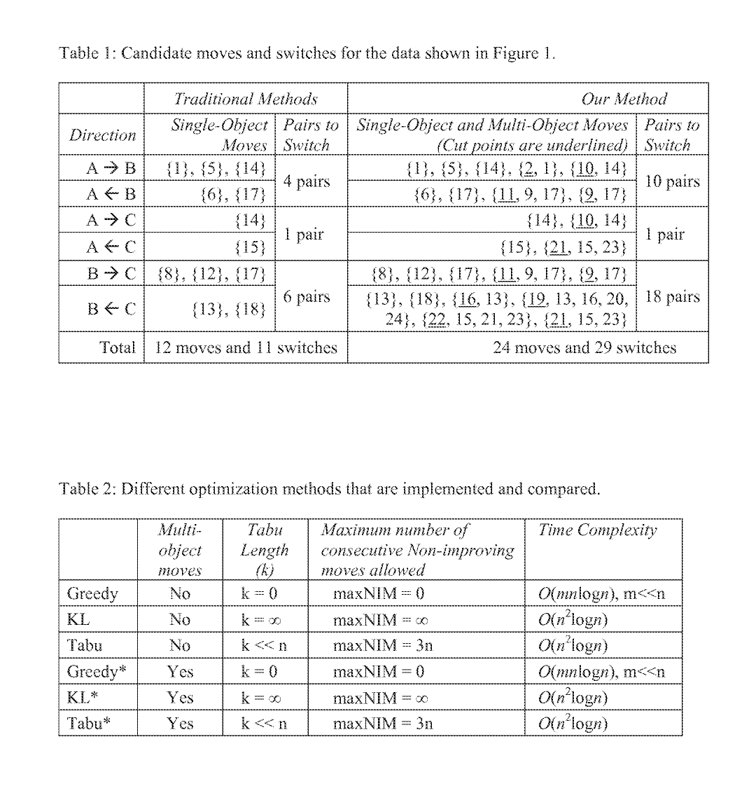

Existing trajectory-based optimization methods only consider moving a single object or switching two objects at each iteration during the optimization process. However, under the contiguity constraint, the search space is very limited with such single-object moves or switches. FIG. 1 shows a simple example data set of 25 spatial objects (polygons), which are initially grouped into three districts: A, B, and C. Between districts A and B, for example, three objects (1, 5, 14) can move from A to B and two objects (6 and 17) can move from B to A. Other objects in A or B cannot move since each will break the contiguity of either A or B. Among the above five objects, 4 pairs may be switched (namely, 1 and 17, 5 and 6, 5 and 17, 14 and 6). Therefore, there are only 9 candidate moves (or switches) between districts A and B. Utilization of the methods of the present disclosure can result in 19 candidate moves (or switches) being found.

### Single-Object Moves and Multi-Object Moves

To addresses the above problem, i.e., limited search space under contiguity constraint, an approach is described that systematically analyzes the neighboring relationship among objects in each district and finds multi-object (or composite) moves for those objects that cannot move alone. If an object u is on the border between two districts but cannot move due to contiguity constraint, the described method will identify a minimal set of objects (including u) that will move together in order to maintain the contiguity of both districts. For example, in FIG. 1, although object 10 in district A cannot move to district B, it can move together with object 14. Similarly, in FIG. 1 there are eight objects (namely, objects 2 and 10 in A, 9 and 11 in B, and 16, 19, 21, and 22 in C) cannot move with traditional methods. In accordance with the present approach, each of them can make a multi-object (composite) move. Table 1 shows the all single- and multi-object moves by the present method.

For the simple data set shown in FIG. 1, a traditional Tabu search can find 23 candidate moves (or pair switches) while the present method can find 53 candidate moves (or switches) (Table 1). In other words, for this example data set, the options are more than doubled at each iteration with the present method. Since this step many times during the optimization search to generate a sequence (trajectory) of moves, the search space is expanded exponentially. This dramatically increases the possibility to escape local optima and significantly improve optimization quality and reliability.

### Efficient Algorithm for Identifying Multi-Object Moves

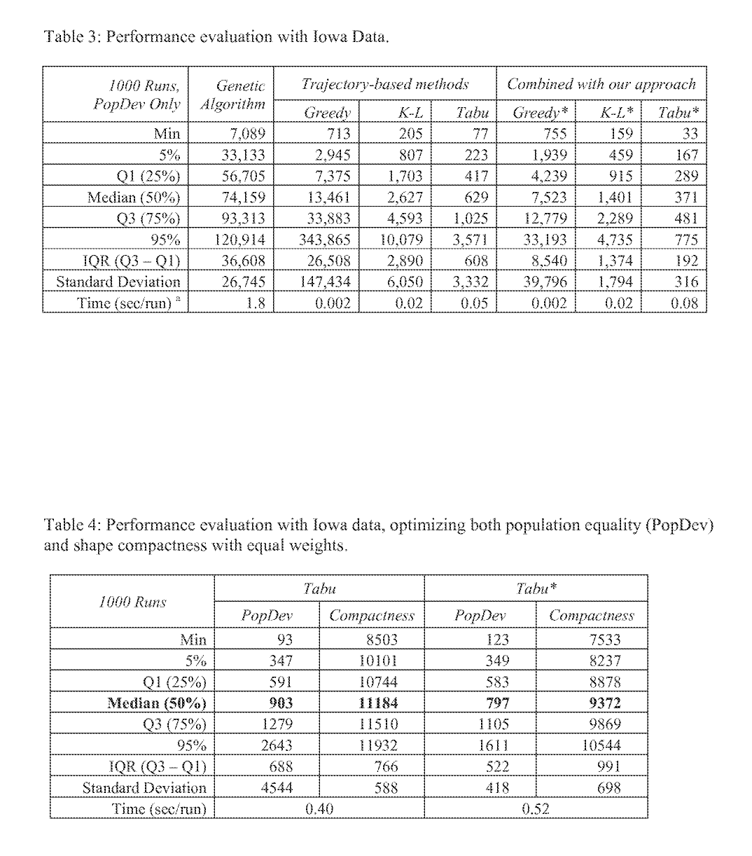

An algorithm is presented that can efficiently find all candidate moves (including both single-object moves and multi-object moves) in linear time. The contiguity relations among spatial objects within a district can be viewed as a graph G, where each spatial object is a node and two geographic neighbors are connected with an edge (FIG. 2). If the removal of an object u from G cuts the graph into two or more disconnected components, object u is called an articulation point (a.k.a. cut point) in G. A biconnected component is a maximal sub-graph of G that cannot be disconnected by deleting any object. The contiguity graph of district C in FIG. 1 is shown in FIG. 2, which has four cut points and five biconnected components.

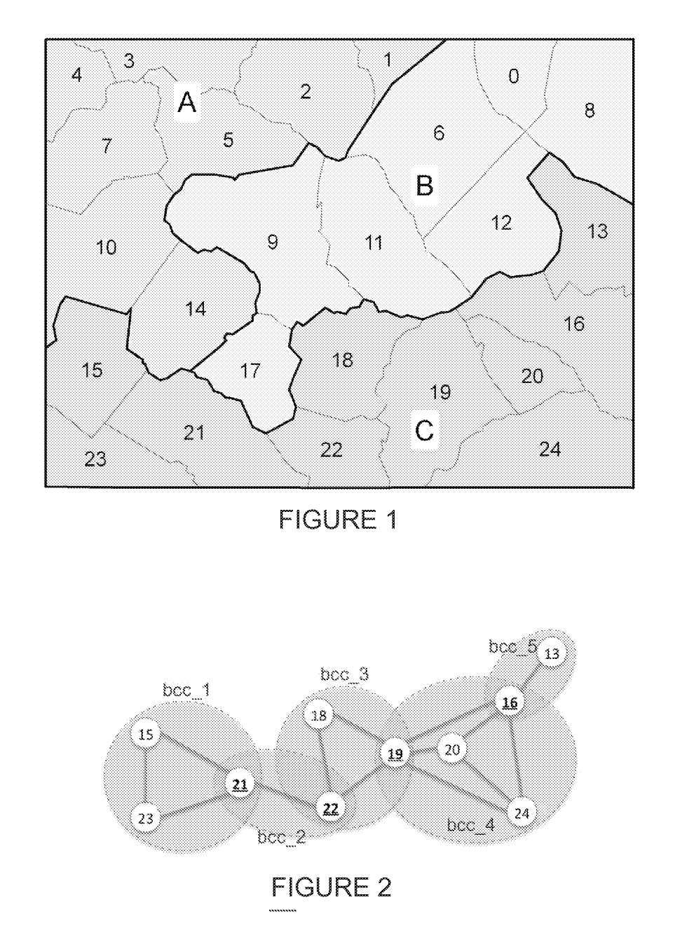

First, the algorithm finds all cut points and biconnected components in each district (FIG. 2) with a depth-first search (DFS) method. The complexity of the DFS algorithm is O(n). For each cut point, a multi-object move can then be found, as shown in FIG. 3.

Second, the algorithm identifies a multi-object move for each cut point (see Algorithm 3). By definition, biconnected components (BCCs) are connected only through cut points. If each BCC is viewed as a single “object”, the contiguity graph becomes a spanning tree, with cut points as the connecting “edges” (see FIG. 2). A BCC is a leaf in this tree if it only connects to one cut point (such as bcc_1 and bcc_5 in FIG. 2). Since the removal of a cut point can cut a graph into two or more components, the strategy of the present disclosure is to let the largest component represent the district and combine other components with the cut point to make a multi-object move. The size of a component can be defined as the number of spatial objects it contains or by other quantitative measures (such as the total population). The algorithm starts from a leaf BCC and traverses the tree from bottom up to find all multi-object moves. During the scan, the attribute values within a multi-object move are aggregated so that each multi-object move becomes a new “object”. Aggregating information within a multi-object move speed up the search for the best move since it does not need to visit all objects in each multi-object move.

Algorithm 3: Identifying Multi-Object (Composite) Moves

```
Inputs:
  S_{d}: the set of spatial objects in a district d;
  C_{d}: a contiguity matrix of the objects in S_{d};
  A_{d}: attribute vector for each object in S_{d};
Steps:
    CompositeMoves = Ø; LeafBCC = Ø;
  1. Find all cut points and biconnected components with DFS (S_{d}, C_{d}).
    bcc.CPT: the set of cut points that a biconnected
    component bcc contains;
    cpt.BCC: the set of biconnected components that
    a cut point cpt belongs to;
    cpt.maxC = Ø, which will keep the largest component for cpt;
    cpt.restC = Ø; which will keep the union of other components of cpt;
  2. For each biconnected component bcc:
      If (|bcc.CPT| = 1), add bcc to LeafBCC;
  3. Repeat the following steps until LeafBCC is empty;
    bcc = next biconnected component in LeafBCCs;
      If bcc.CPT is not empty, perform the following steps:
    cpt = the only cut point in bcc.CPT;
      If size(bcc)> size(cpt.maxC):
        cpt.restC = cpt.restC ∪ cpt.maxC;
        cpt.maxC = bcc;
      Else: cpt.restC = cpt.restC ∪ bcc;
      Remove bcc from cpt.BCC;
    If |cpt.BCC| = 1 and size(cpt.maxC) <size(S_{d})-
    size(cpt.maxC ∪ cpt.restC) +
      1
        cpt.restC = cpt.maxC ∪ cpt.restC;
        bccr = the only remaining biconnected component in cpt.BCC:
        cpt.BCC = Ø;
        Remove cpt from bccR.CPT;
        If (|bccR.CPT| = 1)
          Add bccr to LeafBCC;
    If cpt.BCC = Ø:
        cpt = aggregation of the vectors A_{d} in cpt.restC;
        Add cpt to CompositeMoves as a new composite move.
```

The time complexity of Algorithm 3 is O(n), where n is the number of objects in the district. Algorithm 3 is repeated for each district. Each non-cut point forms single-object move and each cut point leads a multi-object move. Out of these moves, those on the border of two districts will be considered candidate moves. Table 1 shows all candidate moves between neighboring districts. The same object (e.g., object 14 in A) may move to different neighboring districts (e.g., B or C), which are viewed as two different candidate moves. The list of candidate moves is updated after making a move (and thus creating a new plan), which is repeated many times in the optimization process (Step 2 in Algorithm 1).

### Pair Switch of Candidate Moves

Pair switches (i.e., exchanging two candidate moves between two neighboring districts) are often needed to achieve better scores on certain criteria (such as equal population in redistricting). Comparing to those existing methods that consider pair switches, the present pair switching is unique since a switch may involve more than two objects. As shown in FIG. 1, for example, {2, 1} and {9, 17} can be switched to their opposite district. However, not all pairs can be switched due to the contiguity constraint. For example, in FIG. 1, object 14 and object 17 cannot be switched although each can move. This issue can be solved by checking the following condition. Let M₁ and M₂ be two candidate moves, B₁ and B₂ be the boundary shared by each move with their destination district, respectively. Let Bₛ be the shared boundary between M₁ and M₂. If B₁⊂Bₛ or B₂⊂Bₛ, then the two moves cannot be switched. Table 1 shows the total number of valid pair switches between neighbouring districts.

### Objective Function

Different optimization problems often use very different objective functions. Since the present disclosure uses redistricting to present the method, the criteria commonly used in redistricting will be focused on. In addition to the contiguity constraint, population equality is the most important criteria in redistricting, as stated in laws and state constitutions in the U.S. However, to limit gerrymandering in practice, other criteria may also be considered (which vary from case to case), such as compactness of district shape, preserving communities of interest, and respecting existing political boundaries. Some criteria (e.g., “communities of interest”), however, are often vaguely defined and require user inputs and subjective interpretation. Therefore, for clear comparison and visual checking of quality, two commonly used, well defined, and probably also the most challenging criteria in redistricting are chosen: population equality and compactness of district shape.

Population equality requires that the population of each district must be as equal as possible to ensure “one person one vote”. It is measured by “population deviation” (PopDev)—the sum of absolute differences between each district's actual population (pᵢ) and its ideal population, which is the total population (Pop) divided by the number of districts r.

$$PopDev = {\sum }_{i = 1}^{r} \vert {p}_{i} - \frac{Pop}{r} \vert \qquad ( 1 )$$

There are a number of compactness measures for district shape. The Polsby-Popper measure was chosen, which is commonly used in redistricting. The Polsby-Popper Index (PPI) measures the compactness of a district P as the ratio between the district area (α) and the area of a circle that has the same perimeter (ρ) as that of P (see Equation 2). The PPI measure of a shape ranges between 0 and 1, with 1 representing a perfect circle.

PPI=4πα/ρ² (2)

To be able to combine with the population equality measure, the PPI measure is reversed and normalized to get a derived compactness measure for each district. The sum of all districts' compactness values represents the compactness of a plan, as shown in Equation 3, where Pop is the total population of all districts. The normalized PPI measure of each district ranges between 0 (a perfect circle) and 0.1% of the total population.

$$Compactness = {\sum }_{i = 1}^{r} \frac{Pop}{1000} ( 1 - {PPI}_{i} ) \qquad ( 3 )$$

The overall objective function ƒ is a weighted total of the chosen criteria, which in this disclosure are PopDev and Compactness. For different applications, one can configure the objective function with a different set of criteria and weights.

### Efficient Evaluation of Candidate Moves

Based on a given objective function ƒ, each candidate move m has a score δₘ, which is the difference in objective value caused by the move. In other words, δₘ=ƒ(P)−ƒ(Pₘ), where P is the current plan and Pₘ is the new plan after making the move m. The move with the largest score is the best move (assuming the objective function is to be minimized). To achieve the best possible efficiency, the score for each move is calculated based on its aggregated attribute values and the aggregated information of the two involved districts. This strategy is called “dynamic scoring.” For example, given two districts A and B, and a set of candidate moves between them, the aggregated attribute values are first calculated for each district (such as its total population and dissolved shape boundary). Then the score of each move can quickly be calculated based on its aggregated attribute values (such as its population and dissolved shape, which are calculated during the search of candidate moves). As such, scores of all moves can be calculated to determine the best move in linear time.

### Efficient Evaluation of Pair Switches

Evaluating pair switches can be time consuming if all possible pairs are enumerated and evaluated. Based on the fact that pair switches are mainly used to optimize population equality, a strategy has been developed to efficiently find the best switch without enumerating all pairs. Suppose there are two districts A and B, each having a set of candidate moves. To find the best pair to switch, the moves in each district are ordered by their population. Then, given a move u in A, its population, and the population of A and B, the target population can be calculated of an ideal move in B to switch with u. Since the moves in B are already ordered, with a binary search the move m in B can be quickly located with a population that is closest to the target population. A certain number of moves on both sides of m are then searched in the ordering to find the “best” move v to switch with u in terms of the overall objective function. Note that this “best” move is for paring with u only. Repeat this for each move in A, the best switch between A and B can be determined. The time complexity for evaluating pair switches is O(n log n), where n is the number of moves in A and B. The best move identified previously is compared with the best switch identified here to determine which is the overall best move.

### Optimization

An initialization method, an efficient algorithm for identifying candidate moves under contiguity constraint, an object function, and several strategies have been discussed to efficiently evaluate moves. The present disclosure further contemplates a Tabu search algorithm that integrates all of the above steps to efficiently and effectively derive high-quality redistricting plans. Tabu search has been used in many different applications and been shown to outperform alternative approaches. The present implementation of the Tabu search algorithm is shown in FIG. 4. The optimization procedure seeks to improve the initial plan by iteratively moving objects from one district to another. Note that the best move represents the best among all moves and their pair switches. After the best move being accepted, the list of candidate moves will be updated and a new best move will be found. This process repeats until a stopping condition is met.

What makes Tabu search unique is its short-memory strategy to avoid paths that are already investigated and thus may force the search to escape local optima. Specifically, the search process uses a tabu list to remember the most recent moves, which are prohibited to move again until they are removed from the list. The length of the Tabu list (k—the number of prohibited moves) is normally much smaller than the data set size (n). In experiments, k=0.08n. A Tabu search allows non-improving moves, i.e., it is acceptable that the best move does not improve the objective value. By allowing non-improving moves it hopes to escape a local optima and eventually found a better solution. The search stops when the number of consecutive non-improving moves exceeds a threshold (maxNIM). In the experiments, maxNIM=3n.

By changing several parameters, the Tabu search algorithm can easily be converted (FIG. 4) to two other trajectory-based optimization methods: the local greedy search and the Kernighan-Lin algorithm. To make it a local greedy search, set k=0 (i.e., no tabu) and maxNIM=0 (i.e., does not allow non-improving moves). To make it a Kernighan-Lin algorithm, set k=∞ and maxNIM=∞ (i.e. each move can move once and only once—in this case the search stops when there is no valid move). Local greedy search only accepts improving moves and stops at a local optimal. It is fast but often poor in optimization quality. The Kernighan-Lin algorithm was originally developed for graph partitioning and has been used in many applications such as complex network analysis.

By turning on and off the contiguity enforcing approach (which allows multi-object moves, as explained herein), the algorithm presented above can be configured to become six different methods, as summarized in Table 2. If multi-object moves are not allowed, three traditional trajectory-based optimization methods are available: local greedy search (hill climbing), Kernighan-Lin (K-L) algorithm, and Tabu search. If the new contiguity-enforcing approach is integrated to allow multi-object moves, three new optimization methods are available: Greedy*, K-L*, and Tabu*, where the star (*) indicates the capability of multi-object moves. As described in the Examples, each of the three new methods significantly outperforms its traditional version by a large margin.

A genetic algorithm was also implemented for comparison. The genetic algorithm starts with a set of initial plans (generated with the algorithm described herein). Each plan has a fitness value (i.e., its objective function value). Pairs of these plans are then selected and recombined to produce the next generation. The probability for a parent plan to be selected to produce the next generation is based on its fitness value. To generate a new plan, the two selected parent plans are overlaid to generate a set of subdivisions, each of which represents a group of objects that are spatially contiguous and in the same district in both parent plans. Then each subdivision is iteratively merged with its smallest neighbor until the required number of districts is achieved. With a low probability (e.g., 5%), a mutation operation is performed on the new plan by randomly reassigning objects to neighboring districts. In the described experiments, each generation has 50 plans and the evolution continues for 200 generations. The best plan found during the evolution is output as the final plan.

Additionally, further improvements to the algorithm scalability to process large data can include one or more of the following;

1.1. Multi-level aggregation to speed up optimization

A multi-level aggregation to speed up the algorithm for handling large data sets in optimization, which includes the following steps:

(1) given a very large data set, aggregate the units into larger regions (each being spatially contiguous) based on chosen criteria;

(2) perform redistricting optimization with the derived regions using our algorithm aforementioned; and

(3) fine-tune the solution (plan) from step 2 based on the original units.

1.2. Multi-level redistricting by creating mega districts first

A two-level or multi-level, divide-and-conquer approach is developed. For a large data set, such as 25,000 VTDs, and about 500,000 blocks in the state of California, the approach can first divide the state into a small number (of the user's choice) of mega districts with larger units (e.g., counties) according to chosen criteria. With an interactive process, a list of mega-district plans can be generated. After partitioning the space (e.g., California) into a set of mega districts, the user then use the algorithm to partition each mega district separately.

1.3. Cloud-based parallel computing to enhance optimization speed

The algorithm can be deployed on parallel computing platform. The algorithm takes two steps to optimize. (1) create an initial random plan that satisfies all constraints, and (2) optimize the initial plan with heuristic-based searches (e.g., Tabu search) to satisfy all criteria. On a cloud platform, a number of instances can be started simultaneously and report the best result.

1.4. User editing of computer-generated plans

The system design allows users edit any plan generated by the computer algorithm by selecting one or more units in one district and move it to a neighboring district. The system automatically checks the spatial contiguity constraint and only automatically suggest destination district that the selected units can be moved too. This way, the user cannot break the contiguity unintentionally.

1.5. Ability to integrate multiple criteria simultaneously

The present approach and system categorize and integrate different criteria in a general framework and the user can select any subset of the criteria to solve different districting problems. Following are the criteria that are considered in the approach.

(1) Geographic constraints such as spatial contiguity, must-link constraint, cannot-link constraint, and fixed location constraint. Contiguity constraint requires that each district must be contiguous. Must-link constraint requires two objects must stay in one district, while cannot-link constraint means the opposite. Many districting problems, especially service districting problems, require that each district contains exactly one fixed location. These constraints can be treated similarly, where the spatial connectivity are checked when a plan is initialized and when objects are moved between districts. Moreover, by exploiting such constraints, a more efficient strategy can be constructed to only explore the search space that satisfying the constraints.

(2) Balance of district sizes such as equal population, equal household, balance of workload, balance of the demand, etc. These criteria require that a certain measure or variable value be nearly the same across all districts. To optimize such criteria, the optimization method can adopt specialized strategy to efficiently find candidate solutions such trading units between districts and building indices to speed up such searches. This group of criteria can either be integrated in the objective function or treated as constraints (where the measure value must be within a certain range to a target value).

(3) District-specific targets such as majority-minority districts. This type of criteria is only evaluated for certain districts. For example, a majority-minority district is a district where a minority constitutes the majority of the voting age population in the district. There may be a required number of such districts for a specific redistricting task. Such criteria require that the optimization process be able to achieve different target values for different districts.

(4) Global criteria such as compactness, total workload, travel distance, similarity to the existing plan, and preserving the boundaries of political boundaries. The uniqueness of such criteria lies in the fact that the solution is evaluated as a whole. This type of criteria is evaluated by looking at its global impact. For example, trading two units or two groups of units between two school districts may significantly change the short-path bus route in one or both. These criteria have no specific target for a district but a general target for the whole plan.

(5) Vague and subjective criteria such as preserving communities of interest or neighborhood, where different user may have different definition or understanding of “neighborhood” or “communities”. Therefore, communities of interest or neighborhood usually cannot be clearly defined, and local knowledge is needed. To incorporate such criteria, visual interface and user interactions are needed so that the user can choose or draw neighborhoods on the map and then the computational algorithms can consider those inputs. This is a process that integrates human judgments and computational algorithms.

The systems and methods discussed herein can be implemented using servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes can be implemented using a single server or multiple servers working in combination. Databases and applications can be implemented on a single system or distributed across multiple systems. Distributed components can operate sequentially or in parallel.

When data is obtained or accessed between a first and second computer system or component thereof, the actual data can travel between the systems directly or indirectly. For example, if a first computer accesses a file or data from a second computer, the access can involve one or more intermediary computers, proxies, and the like. The actual file or data can move between the computers, or one computer can provide a pointer or metafile that the second computer uses to access the actual data from a computer other than the first computer, for instance.

The various computer systems that can be utilized with the present disclosure are not limited to any particular hardware architecture or configuration. Embodiments of the methods and systems set forth herein can be implemented by one or more general-purpose or customized computing devices adapted in any suitable manner to provide desired functionality. The device(s) can be adapted to provide additional functionality complementary or unrelated to the present subject matter, as well. For instance, one or more computing devices can be adapted to provide desired functionality by accessing software instructions rendered in a computer-readable form. When software is used, any suitable programming, scripting, or other type of language or combinations of languages can be used to implement the teachings contained herein. However, software need not be used exclusively, or at all. For example, some embodiments of the methods and systems set forth herein can also be implemented by hard-wired logic or other circuitry, including, but not limited to application-specific circuits. Of course, combinations of computer-executed software and hard-wired logic or other circuitry can be suitable, as well.

Embodiments of the methods disclosed herein can be executed by one or more suitable computing devices. Such system(s) can comprise one or more computing devices adapted to perform one or more embodiments of the methods disclosed herein. As noted above, such devices can access one or more computer-readable media that embody computer-readable instructions which, when executed by at least one computer, cause the at least one computer to implement one or more embodiments of the methods of the present subject matter. Additionally or alternatively, the computing device(s) can comprise circuitry that renders the device(s) operative to implement one or more of the methods of the present subject matter.

Any suitable computer-readable medium or media can be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other memory devices, and the like.

The present disclosure also can also utilize a relay of communicated data over one or more communications networks. It should be appreciated that network communications can comprise sending and/or receiving information over one or more networks of various forms. For example, a network can comprise a dial-in network, a local area network (LAN), wide area network (WAN), public switched telephone network (PSTN), the Internet, intranet or other type(s) of networks. A network can comprise any number and/or combination of hard-wired, wireless, or other communication links.

The present disclosure can be better understood with reference to the following examples.

### EXAMPLES

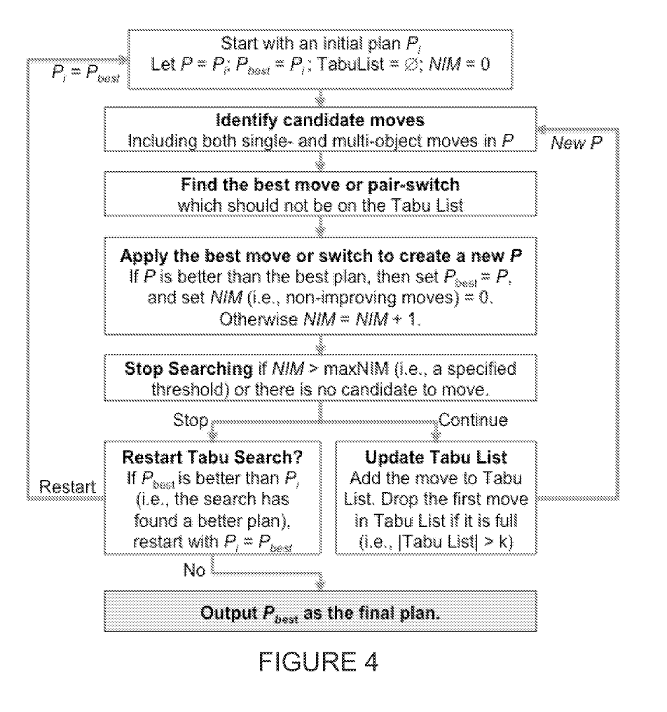

The Iowa congressional redistricting and the 2000 census data was utilized as a case study to evaluate the performance of the disclosed contiguity enforcing approach and the new optimization methods (i.e., Greedy*, K-L*, and Tabu*). Iowa has 99 counties, which are to be divided into five congressional districts (FIG. 5). The total population is 2926324. Therefore the ideal population for each district is 585265. The Iowa constitution requires that a congressional district should have a population as nearly equal as practicable to its ideal population and that each district should be square, rectangular, or hexagonal in shape to the extent permitted by natural or political boundaries (see http://www.legis.state.ia.us/IACODE/2001/42/4.html). The Iowa Code also explicitly specifies that the compactness requirement is subservient to the requirements concerning population equality, respect for political subdivisions (such as county boundaries), and geographic contiguousness. In the present examples, two spatial objects (e.g., counties) are considered contiguous if they share at least a segment of border (in other words, sharing a single point is considered contiguous).

The first example considers only the population equality criterion (PopDev). Seven methods are compared, including the genetic algorithm, local greedy search (Greedy), Kernighan-Lin (K-L), Tabu search, Greedy*, K-L*, and Tabu*. Each method is run 1000 times to derive 1000 plans that optimize the population equality criterion. Note that each run will begin with a different initial plan and thus most likely produce different final plans. The seven methods are then compared based on the objective scores of their 1000 final plans. Table 1 presents results for the first experiment, including the minimum (best) value, 5^{th} percentile, 25^{th} percentile (the lower quartile, Q1), 50^{th} percentile (the median), 75^{th} percentile (the upper quartile, Q3), and 95^{th} percentile of the 1000 PopDev scores for each method. To examine the reliability of each method, Table 1 also shows the interquartile range (IQR=Q3−Q1) and the standard deviation.

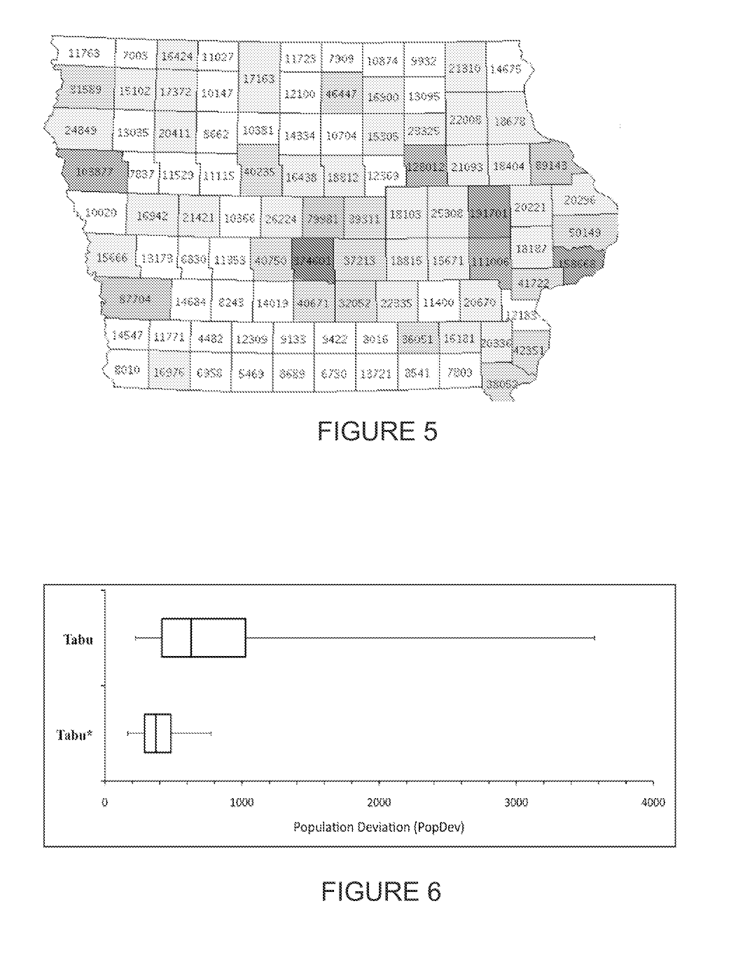

Results show that, with the described contiguity enforcing approach, each of the three new methods (Greedy*, K-L*, and Tabu*) significantly outperforms their traditional version by a large margin, with p-value <2e⁻¹⁶, tested with the Mann-Whitney-Wilcoxon (MWW) method. Particularly, the Tabu* method is significantly better than other methods in terms of both optimization quality (objective scores) and performance reliability (measured by IQR and standard deviation) (see FIG. 6). Note that, although the Iowa data is small, it is a more difficult optimization problem than with more spatial objects. For example, when applied to partition 2700+ voting tabulation districts (VTD) of South Carolina into 6 congressional districts, the Tabu* method can find many global optimal solutions (i.e., PopDev=0).

Another example considers both PopDev and Compactness, equally weighted. Similarly, the three new methods outperform their traditional version by a large margin and Tabu* is the best among all. Table 4 shows the results for Tabu and Tabu*, where the latter is significantly better than the former in both population equality (PopDev) and shape (Compactness). The running time is longer since processing shapes are more time consuming than processing population but the overall time complexity remains the same, i.e., O(n² log n).

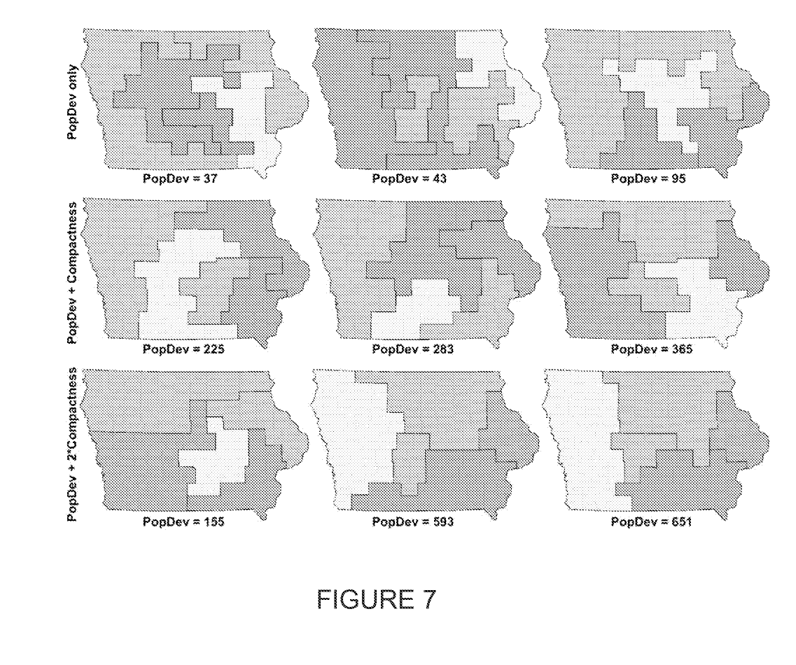

FIG. 7 shows several selected redistricting plans generated by the Tabu* method with three different configurations: (1) consider PopDev only; (2) consider both PopDev and Compactness with equal weights; and (3) consider both PopDev and Compactness but give the latter more weight. Please note that the method can generate hundreds of plans within minutes and only three examples are shown for each configuration here. The results clearly show the capability of the new method, which can quickly generate many high-quality and practically usable plans. For example, the last three maps shown in FIG. 3 are all comparable with and even better than the current official plan in Iowa, based on the criteria set by the Iowa Code.

An efficient and effective approach to enforcing geographic contiguity in combinatorial optimization has been introduced, which can significantly improve the optimization performance of existing trajectory-based metaheuristic optimization methods such as Tabu search or local greedy search. The approach analyzes the contiguity relationship among objects in each district and allows single-object moves, multi-object moves, and switches of moves during the optimization search. The approach has been combined with three traditional trajectory-based optimization methods (namely local greedy search, Kernighan-Lin algorithm, and Tabu search) and it has been determined that its integration with the Tabu search method gives the best optimization power. Moreover, through several efficient strategies, the new Tabu method achieves an O(n² log n) complexity. Through experiments with the Iowa congressional redistricting problem, the capability of the new approach has been demonstrated, which significantly outperforms existing methods in terms of both optimization quality and reliability.

With the much improved optimization power, the approach can find a large number of high-quality and yet different solutions for even a relatively small data set. By adding more restrictive criteria (such as considering compactness and giving it a high weight), more duplicates in the final solutions will be realized (i.e., different initial plans lead to the same final plan) but there are still many different excellent plans (some of which are shown in the bottom row in FIG. 7). With such optimization power, it is possible to further allow users add individual preferences (such as requiring that a certain group of objects to be always in the same district) and force the algorithm to discover high-quality plans that meet specific needs. Other possible applications include redrawing precinct lines, school redistricting, city annexation, or the like.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure.

What is claimed is:

1. A computer implemented method for enforcing geographic contiguity of an optimization method for redistricting comprising:
randomly grouping a data set of objects into geographically contiguous districts;
optimizing the objects by iteratively moving one or more objects between neighboring districts, wherein a relationship of objects is analyzed in each district to determine a minimal set of objects that will move together to maintain contiguity between districts; and
generating one or more solutions for the data set.

2. The method of claim 1, further comprising:
determining all cut points and bioconnected components in each district and identifying a multi-object move for each cut point.

3. The method of claim 1, further comprising optimizing population equality of districts.

4. The method of claim 1, further comprising optimizing compactness of districts.

5. The method of claim 1, wherein a trajectory-based optimization method is utilized to optimize the objects.

6. The method of claim 5, wherein the trajectory-based optimization method comprises a Tabu optimization algorithm.

7. The method of claim 5, wherein the trajectory-based optimization method comprises a local greedy search optimization algorithm.

8. The method of claim 5, wherein the trajectory-based optimization method comprises a Kernighan-Lin algorithm optimization algorithm.

9. The method of claim 1, further comprising presenting one or more solutions to a user via a graphical user interface.

10. A computer system comprising memory and a process, the computer system being configured to enforce geographic contiguity of an optimization method for redistricting by performing operations comprising:
randomly grouping a data set of objects into geographically contiguous districts;
optimizing the objects by iteratively moving one or more objects between neighboring districts, wherein a relationship of objects is analyzed in each district to determine a minimal set of objects that will move together to maintain contiguity between districts; and
generating one or more solutions for the data set.

11. The computer system of claim 10, wherein optimizing the objects comprises:
determining all cut points and bioconnected components in each district and identifying a multi-object move for each cut point.

12. The computer system of claim 10, the operations further comprising optimizing population equality of districts.

13. The computer system of claim 10, the operations further comprising optimizing compactness of districts.

14. The computer system of claim 10, wherein a trajectory-based optimization method is utilized to optimize the objects.

15. The computer system of claim 10, wherein the trajectory-based optimization method comprises a Tabu optimization algorithm.

16. A non-transitory computer-readable medium storing instructions that when executed by at least one processor cause the at least one processor to perform operations comprising:
randomly grouping a data set of objects into geographically contiguous districts;
optimizing the objects by iteratively moving one or more objects between neighboring districts, wherein a relationship of objects is analyzed in each district to determine a minimal set of objects that will move together to maintain contiguity between districts; and
generating one or more solutions for the data set.
